(19) United States
(12) Patent Application Publication
(10) Pub. No.: US 2010/0310293 A1
(43) Pub. Date: Dec. 9, 2010

(54) IMAGE FORMING APPARATUS AND METHOD OF MEASURING AMOUNT OF SKEW IN IMAGE FORMING APPARATUS

(75) Inventor: Naofumi SOGA, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/794,537

(22) Filed: Jun. 4, 2010

Related U.S. Application Data
(60) Provisional application No. 61/184,723, filed on Jun. 5, 2009.

(51) Int. Cl. G03G 15/00

(52) U.S. Cl. 399/395

(57) ABSTRACT

An image forming apparatus includes: a media sensor which is locked in the middle of a recording medium carrying path, to which a magnetic sensor is locked so that the output of the magnetic sensor varies when a actuator having a magnet at one end thereof is displaced in a thrust direction, and which senses the thickness of the recording medium; a stopper having a nipping portion at a distal end thereof and returning the actuator to a home position; and a controller sensing the output of the magnetic sensor twice with a time interval therebetween and calculating an amount of skew of the recording medium on the basis of the time interval and the sensed variation in the output of the magnetic sensor.

### CROSS-REFERENCE TO RELATED APPLICATIONS

This application is based upon and claims the benefit of priority from the prior U.S. Patent Application No. 61/184,723, filed on Jun. 5, 2009, the entire contents of which are incorporated herein by reference.

### FIELD

The present embodiment relates to an image forming apparatus measuring an amount of skew of a carried recording medium using a media sensor sensing a thickness of the recording medium, and a method of measuring an amount of skew in the image forming apparatus.

### BACKGROUND

In image forming apparatuses such as copiers, MFP (Multifunction Peripherals), and printers, when a skew, that is, a deviation in a direction perpendicular to a recording medium carrying direction, is caused in a carried recording medium, the direction of a formed image may not be matched with the direction of the recording medium.

In view of this problem, a technique of inserting a magnetized lot through a magnetized sleeve, connecting a roller coming in contact with the surface of the recording medium to the sleeve, and reducing an amount of skew by the use of a magnetic field was suggested.

### DESCRIPTION OF THE DRAWINGS

FIG. 1 is a diagram illustrating a configuration of an image forming apparatus.

FIG. 2 is a perspective view illustrating an appearance of a media sensor unit.

FIG. 3 is a perspective view of a media sensor.

FIG. 4 is an enlarged plan view of a distal end of a stopper.

FIG. 5 is a side view illustrating an operation of the stopper.

FIG. 6A is a side view schematically illustrating a configuration of the media sensor.

FIG. 6B is a plan view illustrating a positional relation of a magnet and a magnetic sensor.

FIG. 7 is a diagram illustrating a relation of a deviation in a thrust direction of an arm and an output voltage of the magnetic sensor.

FIG. 8 is a diagram schematically illustrating a configuration of the image forming apparatus.

FIG. 9 is a timing diagram illustrating measurement of an amount of skew of a recording medium in the image forming apparatus.

FIG. 10 is a timing diagram illustrating measurement of an amount of skew of a recording medium in an image forming apparatus according to an application of the invention.

### DETAILED DESCRIPTION

Throughout this description, the embodiments and examples shown should be considered as exemplars, rather than limitations on the apparatus and methods of the embodiment.

Hereinafter, an image forming apparatus and a method of measuring an amount of skew in the image forming apparatus according to an embodiment of the invention will be described in detail with reference to the accompanying drawings. Here, examples of the image forming apparatus include a copier, an MFP (Multifunction Peripheral), and a printer.

The image forming apparatus according to this embodiment includes an image carrier configured to carry an electrostatic latent image; a developer configured to supply toner to develop the electrostatic latent image to a developer image; a fuser configured to fix the developer image transferred to a recording medium; an actuator configured to rotate in a rotational direction according to a thickness of the recording medium and configured to move in a thrust direction; a magnet configured to move according to the rotation and the movement of the actuator; a magnetic sensor configured to produce an output according to a variation in magnetic field produced by the movement of the magnet; a stopper configured to return the actuator to a home position in the thrust direction; and a controller configured to obtain the output plural times with a time interval therebetween, configured to detect an amount of skew of the recording medium on the basis of the time interval and the output, and configured to detect the thickness.

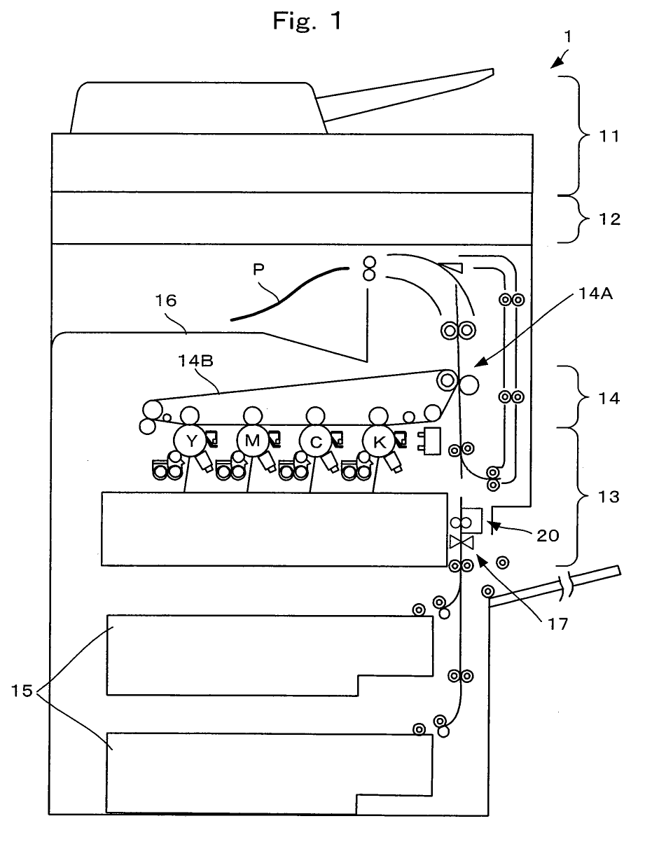

FIG. 1 is a diagram illustrating the configuration of the image forming apparatus 1 according to this embodiment. As shown in FIG. 1, the image forming apparatus 1 includes an automatic document feeder 11, a scanner 12, an image forming section 13, a transfer unit 14, a recording medium carrying mechanism, and a sheet feeder 15.

The image forming apparatus 1 has the automatic document feeder 11 in the top of the main body so as to be opened and closed. The automatic document feeder 11 includes a document carrying mechanism picking up documents sheet by sheet from a paper feeding tray and carrying the picked-up document to a paper discharge tray.

The automatic document feeder 11 carries the documents to a document reading unit of the scanner 12 sheet by sheet by the use of the document carrying mechanism. The automatic document feeder 11 may be opened and a document may be placed on a document plate of the scanner 12.

The scanner 12 includes an exposure lamp exposing a document to light, a carriage having a first reflecting mirror, plural second reflecting mirrors locked in a main frame of the image forming apparatus 1, a lens block, and a CCD (Charge Coupled Device) as an image reading sensor.

The carriage stops at the document reading section or reciprocates under the document plate to cause the first reflecting mirror to reflect light of the exposure lamp reflected from a document. The second reflecting mirrors reflect the light reflected from the first reflecting mirror to the lens block. The lens block changes the magnification of the reflected light and outputs the resultant light to the CCD. The CCD converts the incident light into electrical signals and outputs the resultant signals as image signals to the image forming section 13.

The image forming section 13 includes a laser radiation unit, a photoconductive drum as the electrostatic latent image carrier, and a developer for each of yellow Y, magenta M, cyan C, and black K.

The laser radiation unit radiates a laser beam to the photoconductive drum on the basis of the image signals to form an electrostatic latent image on the photoconductive drum. The developer supplies developer to the photoconductive drum to form a developer image from the electrostatic latent image.

The sheet feeder 15 picks up recording media sheet by sheet from a paper feed cassette and guides the picked-up recording medium to a recording medium carrying mechanism. The recording medium carrying mechanism carries the recording medium to the transfer unit 14.

The transfer unit 14 includes a transfer belt 14B, a transfer roller, and a fuser 14A. The transfer belt 14B as the image carrier transfers and carries the developer image on the photoconductive drum. The transfer roller applies a voltage to transfer the developer image on the transfer belt to a carried recording medium. The fuser 14A heats and pressurizes the developer image to fix the developer image on the recording medium.

The image forming apparatus 1 includes a media sensor unit 20 sensing a thickness of a recording medium in the middle of the recording medium carrying path of the recording medium carrying mechanism. The image forming apparatus 1 has the media sensor unit 20 upstream in the recording medium carrying direction from the fuser 14A of the transfer unit 14.

The image forming apparatus 1 conveys sheets through the recording medium carrying path by the recording medium carrying mechanism.

The image forming apparatus 1 includes an optical sensor 17 sensing the passage of a recording medium upstream in the recording medium carrying direction from the media sensor 20 of the recording medium carrying mechanism.

A recording medium P discharged from a paper discharge port is piled on a paper discharge tray 16.

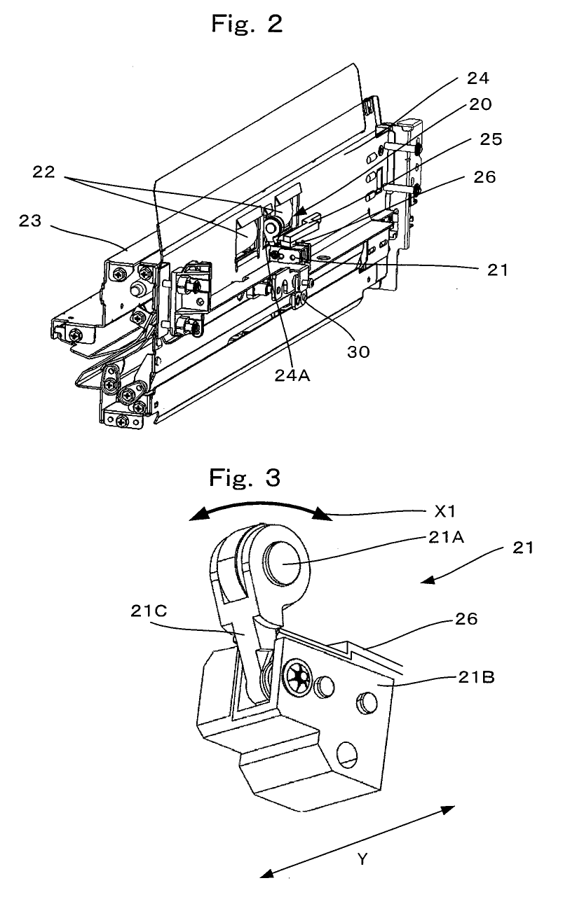

FIG. 2 is a perspective view illustrating the appearance of the media sensor unit 20. As shown in FIG. 2, the media sensor unit 20 includes a media sensor 21, a pair of recording medium carrying driving rollers 22, and a pair of recording medium carrying driven rollers rotating along with the recording medium carrying driving roller 22.

The image forming apparatus 1 includes a first recording medium guide 23 and a second recording medium guide 24. The recording medium is carried through a gap between the first recording medium guide 23 and the second recording medium guide 24. The second recording medium guide 24 includes an opening 24A for bringing a roller 21A of the media sensor 21 into contact with a carried recording medium.

The media sensor 21 is mounted on the second recording medium guide 24 with an anti-vibration damper 30 interposed therebetween.

The image forming apparatus 1 includes a stopper arm 25 fixed to the second recording medium guide 24 and a stopper 26 locked at a distal end of the stopper arm 25.

FIG. 3 is a perspective view of the media sensor 21. As shown in FIG. 3, the media sensor 21 includes the roller 21A and a sensor body 21B. The roller 21A has a roller at one end thereof and the other end is mounted on the sensor body 21B so as to rotate in the direction of arrow X1.

The media sensor 21 senses the thickness of a recording medium, for example, by the use of a magnetic sensor. The media sensor 21 includes a permanent magnet, which is displaced with the rotation of the roller 21A, in the base of the roller 21A. The magnetic sensor disposed in the sensor body 21B senses the variation in magnetic field.

The magnetic sensor varies in electric resistance depending on the magnetic field. The image forming apparatus 1 senses the thickness of the recording medium by sensing the variation in electric resistance.

The stopper 26 nips an actuator 21C of the media sensor 21 to return the actuator 21C deviated in the thrust direction indicated by arrow Y to the home position.

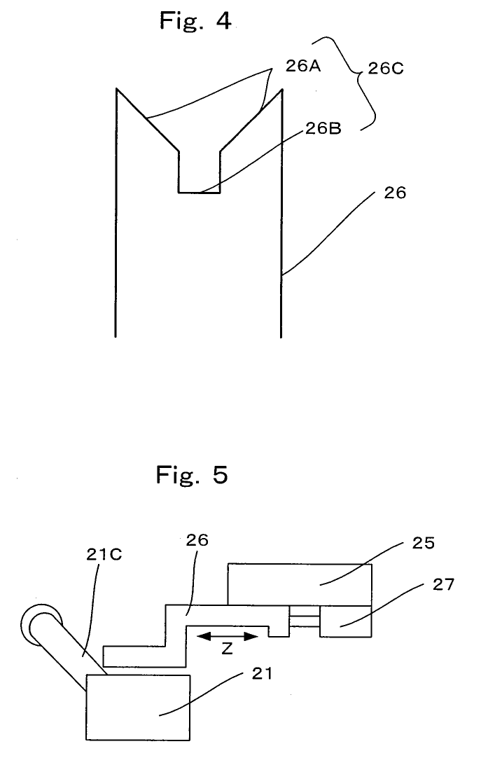

FIG. 4 is an enlarged plan view of a distal end of the stopper 26. As shown in FIG. 4, the stopper 26 has a nipping portion 26C at its distal end. The nipping portion 26C includes a pair of tapered portions 26A tapered inward and an engagement portion 26B connected to the pair of tapered portions 26A and engaging with the actuator 21C.

The width of the tapered portions 26A is greater than the width in the thrust direction of the actuator 21C. The width of the engagement portion 26B is equal to the width in the thrust direction of the actuator 21C.

The stopper 26 is formed of a material such as plastics which can easily slide.

FIG. 5 is a side view illustrating the operation of the stopper 26. As shown in FIG. 5, the stopper 26 has a Z-shaped side surface. The stopper arm 25 includes a solenoid 27 reciprocating in the direction of arrow Z. The stopper 26 is locked to an end of the solenoid 27.

The stopper 26 is locked so that the nipping portion 26C is located at the base of the actuator 21C.

When the solenoid 27 is turned on, the stopper 26 is displaced toward the actuator 21C, the nipping portion 26C nips the actuator 21C, and thus the deviation in the thrust direction of the actuator 21C is returned.

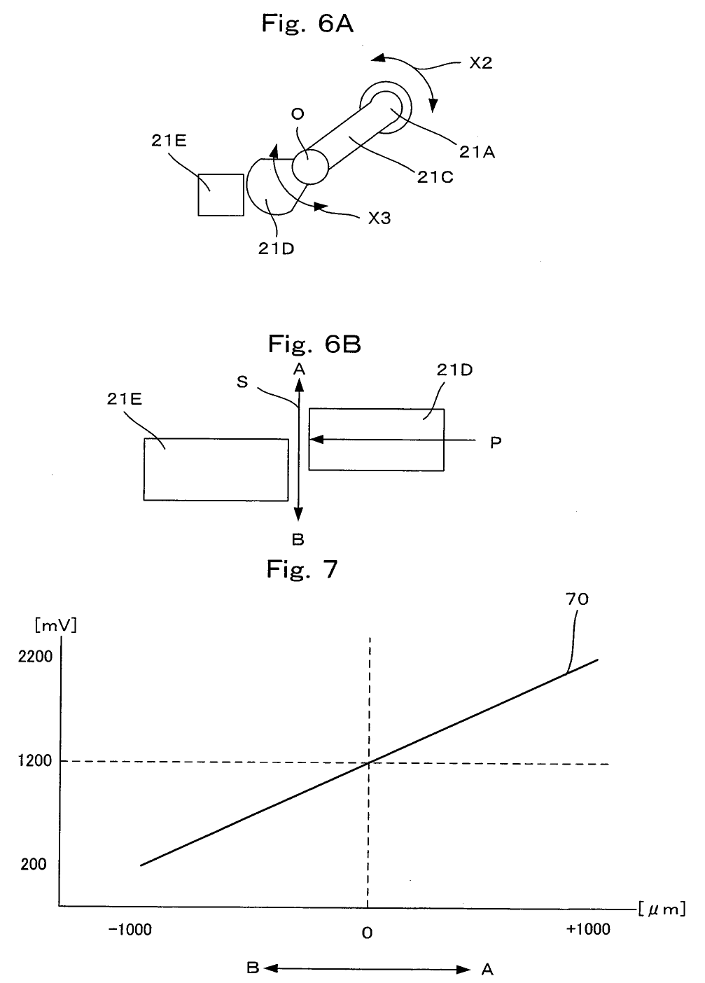

FIG. 6A is a side view schematically illustrating the configuration of the media sensor 21. As shown in FIG. 6A, the actuator 21C has a roller 21A at its distal end and has a magnet 21D at the other end. The base of the actuator 21C is mounted on the frame of the media sensor 21 so as to rotate by a pin O. A magnetic sensor 21E is mounted on the frame of the media sensor 21.

When the roller 21A rotates in the direction of arrow X2, the magnet 21D rotates in the direction of arrow X3 about the pin O. The magnetic sensor 21E senses the variation in magnetic field of the magnet 21D.

FIG. 6B is a plan view illustrating the positional relation between the magnet 21D and the magnetic sensor 21E. As shown in FIG. 6B, when the actuator 21C is located at the home position in the thrust direction, the magnetic sensor 21E is locked so that the edge of the magnetic sensor 21E is matched to the width direction center P, in the thrust direction indicated by arrow S, of the magnet 21D in the thrust direction.

Accordingly, when the actuator 21C is deviated in the direction A of the thrust direction S due to a skew of a recording medium, that is, a deviation in a direction perpendicular to the recording medium carrying direction, the magnetic field sensed by the magnetic sensor 21E decreases. When the actuator 21C is deviated in the direction B of the thrust direction S due to the skew of the recording medium, the magnetic field sensed by the magnetic sensor 21E increases.

FIG. 7 is a diagram illustrating the relation between the deviation in the thrust direction of the actuator 21C and the output voltage of the magnetic sensor 21E. In FIG. 7, the vertical axis represents the output voltage (mV) of the magnetic sensor 21E and the horizontal axis represents the deviation in the thrust direction of the actuator 21C. The graph 70 represents the relation between the deviation in the thrust direction of the actuator 21C and the output voltage of the magnetic sensor 21E.

As shown in FIG. 7, when the actuator 21C is located at the home position O in the thrust direction, the output voltage of the magnetic sensor 21E is 1200 mV.

When the actuator 21C is deviated in the direction A from the home position in FIG. 6B, the output voltage increases. When the arm is deviated in the direction B, the output voltage is lowered.

Accordingly, it is possible to sense the deviation in the thrust direction of the actuator 21C by the use of the output of the magnetic sensor 21E.

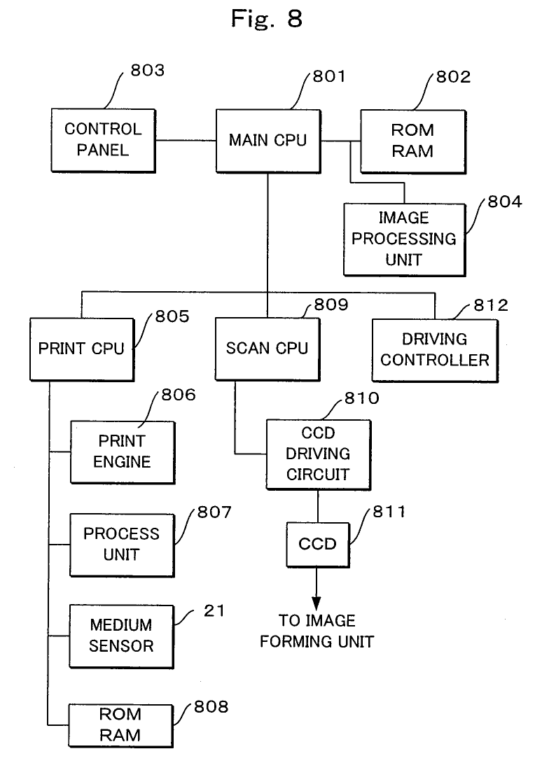

FIG. 8 is a diagram schematically illustrating the configuration of the image forming apparatus 1. As shown in FIG. 8, the image forming apparatus 1 includes a main CPU 801 as a controller comprehensively controlling the image forming apparatus 1, a control panel 803 as a display device connected to the main CPU 801, a ROM and RAM 802 as a memory device, and an image processor 804 performing an image process.

The main CPU 801 is connected to a print CPU 805 controlling the units of an image forming system, a scan CPU 809 controlling the units of an image reading system, and a driving controller 812 controlling the driving unit.

The print CPU 805 controls a print engine 806 forming an electrostatic latent image on a photoconductive drum and a process unit 807 forming a developer image. The print CPU 805 is further connected to the media sensor 21 and a ROM and RAM 808 as a memory device.

The print CPU 805 determines the thickness of a recording medium on the basis of the output of the media sensor 21 and controls the print engine 806 and the process unit 807 on the basis of the thickness of the recording medium.

The scan CPU 809 controls a CCD driving circuit 810 driving a CCD 811. A signal from the CCD 811 is output to the image forming unit.

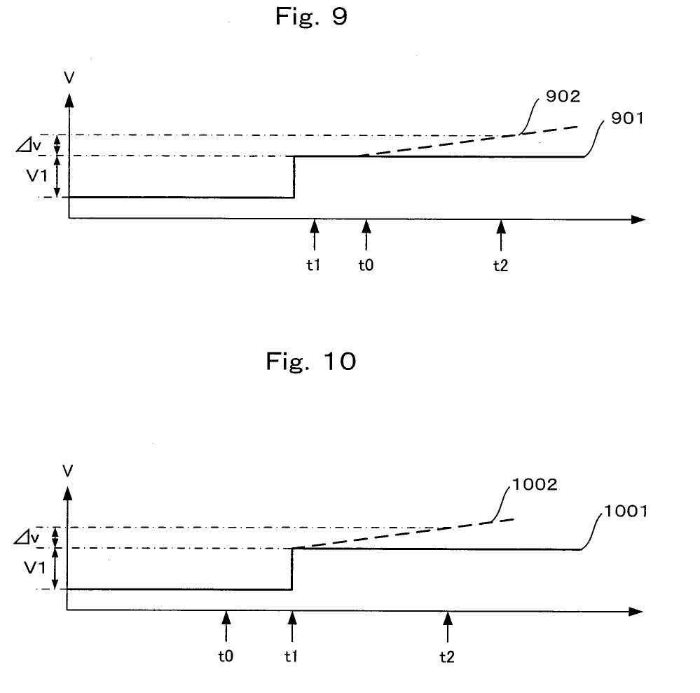

FIG. 9 is a timing diagram illustrating the measurement of the amount of skew of a recording medium in the image forming apparatus 1. In FIG. 9, the vertical axis represents the output voltage (V) of the magnetic sensor 21E and the horizontal axis represents the time. The graph 901 shows the relation between the output of the magnetic sensor 21E and the time when a recording medium is detected.

The image forming apparatus 1 senses the output of the magnetic sensor 21E twice with a time interval therebetween and calculates the amount of skew of the recording medium on the basis of the time interval and the sensed variation in the output of the magnetic sensor 21E.

At the time of sensing the output of the magnetic sensor 21E once, the image forming apparatus 1 samples the output voltage of the magnetic sensor 21E plural times, for example, ten times, to output the sensing result. The once sampling time is 4/1000 seconds. Since the sampling is performed ten times, the image forming apparatus 1 requires 4/100 seconds to output the once sensing result.

The image forming apparatus 1 averages the values acquired by sampling the output voltage of the magnetic sensor 21E ten times and outputs the resultant as the once sensing result.

As shown in FIG. 9, when the media sensor 21 senses a recording medium, the voltage increases by V1. Here, the stopper 26 nips the actuator 21C at the home position up to time t0.

When the stopper 26 is disengaged at time t0, the actuator 21C is displaced from the home position by the skew of the recording medium. When the actuator 21C is displaced from the home position, the output of the magnetic sensor 21E varies. The graph 902 shows this variation.

The image forming apparatus 1 measures the time using the print CPU 805. Specifically, the image forming apparatus 1 sets as a time measurement start point the point when the optical sensor 17 sensing a recording medium is turned on, sets as time t1 the point when a predetermined arrival time of the recording medium at the media sensor 21 passes after the measurement start point, that is, when a time interval passes after the recording medium reaches the media sensor 21, and sets as time t2 the point when a time interval passes after time t1.

First, the image forming apparatus 1 first senses the output voltage of the magnetic sensor 21E at time t1 before disengaging the stopper 26, and stores the first sensed output voltage in the memory device 808.

Then, the image forming apparatus 1 disengages the stopper 26 at time t0, second senses the output voltage of the magnetic sensor 21E at time t2, stores the second sensed output voltage in the memory device 808.

The image forming apparatus 1 calculates the amount of skew defined by Expression 1 using the print CPU 805.

(Amount of skew)=Δv/(t2−t0), Expression 1

where Δv=(second sensed output voltage of magnetic sensor 21E)−(first sensed output voltage of magnetic sensor 21E).

FIG. 10 is a timing diagram illustrating the measurement of an amount of skew of a recording medium in an image forming apparatus 1 according to an application of the invention. In FIG. 10, the vertical axis represents the output voltage (V) of the magnetic sensor 21E and the horizontal axis represents the time. The graph 1001 shows the relation between the output of the magnetic sensor 21E and the time when a recording medium is detected.

As shown in FIG. 10, when the media sensor 21 senses a recording medium, the voltage increases by V1. Here, the stopper 26 nips the actuator 21C at the home position up to time to.

When the stopper 26 is disengaged at time t0, a recording medium is sensed and the actuator 21C is displaced from the home position by the skew of the recording medium. When the actuator 21C is displaced from the home position, the output of the magnetic sensor 21E varies. The graph 1002 shows this variation.

The image forming apparatus 1 measures the time using the print CPU 805. Specifically, the image forming apparatus 1 detects the output of the magnetic sensor 21E plural times, sets as time t1 the point when it is detected that the output of the magnetic sensor 21E is greater than a predetermined threshold value, that is, when the media sensor 21 senses the passage of the recording medium, and sets as time t2 the point when a time interval passes after time t1.

First, the image forming apparatus 1 first senses the output voltage of the magnetic sensor 21E at time t1 before disengaging the stopper 26, and stores the first sensed output voltage in the memory device 808.

Then, the image forming apparatus 1 second senses the output voltage of the magnetic sensor 21E at time t2 and stores the second sensed output voltage in the memory device 808.

The image forming apparatus 1 calculates the amount of skew defined by Expression 2 using the print CPU 805.

(Amount of skew)=Δv/(t2−t1), Expression 2

where Δv=(second sensed output voltage of magnetic sensor 21E)−(first sensed output voltage of magnetic sensor 21E).

The image forming apparatus 1 uses the measured amounts of skew to form an image.

As described above, the image forming apparatus 1 according to this embodiment includes the media sensor 21 which is locked in the middle of the recording medium carrying path, to which the magnetic sensor 21E is locked so that the output of the magnetic sensor 21E varies when the actuator 21C having the magnet 21D at one end thereof is displaced in the thrust direction, and which senses the thickness of the recording medium, the stopper 26 having the nipping portion 26C at a distal end thereof and returning the actuator 21C to the home position, and the controller sensing the output of the magnetic sensor 21E twice with a time interval therebetween and calculating the amount of skew of the recording medium on the basis of the time interval and the sensed variation in the output of the magnetic sensor 21E.

Therefore, the image forming apparatus 1 can measure the amount of skew using the media sensor 21 sensing the thickness of a recording medium without adding a new sensor.

While certain embodiments have been described, these embodiments have been presented by way of example only, and are not intended to limit the scope of the inventions. Indeed, the novel methods and systems described herein may be embodied in a variety of other forms; furthermore, various omissions, substitutions, and changes in the form of the methods and systems described herein may be made without departing from the spirit of the inventions. The accompanying claims and their equivalents are indeed to cover such forms or modifications as would fall within the scope and spirit of the inventions.

What is claimed is:

1. An image forming apparatus comprising:
an image carrier configured to carry an electrostatic latent image;
a developer configured to supply toner to develop the electrostatic latent image to a developer image;
a fuser configured to fix the developer image transferred to a recording medium;
an actuator configured to rotate in a rotational direction according to a thickness of the recording medium and configured to move in a thrust direction;
a magnet configured to move according to the rotation and the movement of the actuator;
a magnetic sensor configured to produce an output according to a variation in magnetic field produced by the movement of the magnet;
a stopper configured to return the actuator to a home position in the thrust direction; and
a controller configured to obtain the output plural times with a time interval therebetween, configured to detect an amount of skew of the recording medium on the basis of the time interval and the output, and configured to detect the thickness.

2. The apparatus according to claim 1, wherein an edge of the magnetic sensor matches with the thrust direction center of the magnet when the actuator is at the home position.

3. The apparatus according to claim 1, wherein the stopper includes a pair of tapered portions tapered inward and an engagement portion connected to the pair of tapered portions and to engage with the actuator.

4. The apparatus according to claim 1, wherein the controller
first obtains the output in a time interval after the recording medium reaches the actuator at a first sensing time,
disengages the stopper from the actuator at a second sensing time after the first sensing time, and
second obtains the output after the second sensing time.

5. The apparatus according to claim 4, wherein the controller calculates the amount of skew by the following expression,
(Amount of skew)=Δv/(second sensing time of output of magnetic sensor−disengagement time of stopper),
where Δv=(second sensed output voltage of magnetic sensor)−(first sensed output voltage of magnetic sensor).

6. The apparatus according to claim 4, further comprising an optical sensor configured to sense the recording medium,
wherein the controller sets as a time measurement start point a point when the optical sensor is turned on, sets as a first output sensing time of the magnetic sensor when a time interval passes after the time measurement start point, sets as a second output sensing time of the magnetic sensor a point when a time interval passes after the first output sensing time of the magnetic sensor.

7. The apparatus according to claim 1, wherein the controller
disengages the stopper from the actuator before the first output sensing of the magnetic sensor,
first senses the output of the magnetic sensor when the recording medium reaches the media sensor, and
second senses the output of the magnetic sensor in a time interval after the first output sensing time of the magnetic sensor.

8. The apparatus according to claim 7, wherein the controller calculates the amount of skew by the following expression,
(Amount of skew)=Δv/(second sensing time of output of magnetic sensor−first sensing time of output of magnetic sensor),
where Δv=(second sensed output voltage of magnetic sensor)−(first sensed output voltage of magnetic sensor).

9. The apparatus according to claim 7, wherein the controller detects the output of the magnetic sensor plural times, sets as the first output sensing time of the magnetic sensor a point when the controller detects that the output of the magnetic sensor is greater than a predetermined threshold value, and sets as the second output sensing time of the magnetic sensor a point when a time interval passes after the first output sensing time of the magnetic sensor.

10. The apparatus according to claim 1, wherein the stopper reciprocates by a solenoid.

11. A method of measuring an amount of skew in an image forming apparatus, comprising:
causing an image carrier to carry an electrostatic latent image;
causing a developer to supply toner to develop the electrostatic latent image to a developer image;
causing a fuser to fix the developer image transferred to a recording medium;
causing an actuator to rotate in a rotational direction according to a thickness of the recording medium and configured to move in a thrust direction;
causing a magnet to move according to the rotation and the movement of the actuator;
causing a magnetic sensor to produce an output according to a variation in magnetic field produced by the movement of the magnet;
causing a stopper to return the actuator to a home position in the thrust direction; and
causing a controller to obtain the output plural times with a time interval therebetween, to detect an amount of skew of the recording medium on the basis of the time interval and the output, and to detect the thickness.

12. The method according to claim 11, wherein an edge of the magnetic sensor matches with the thrust direction center of the magnet when the actuator is at the home position.

13. The method according to claim 11, wherein the stopper includes a pair of tapered portions tapered inward and an engagement portion connected to the pair of tapered portions and to engage with the actuator.

14. The method according to claim 11, wherein the controller
first obtains the output in a time interval after the recording medium reaches the actuator at a first sensing time,
disengages the stopper from the actuator at a second sensing time after the first sensing time, and
second obtains the output after the second sensing time.

15. The method according to claim 14, wherein the controller calculates the amount of skew by the following expression,
(Amount of skew)=Δv/(second sensing time of output of magnetic sensor−disengagement time of stopper),
where Δv=(second sensed output voltage of magnetic sensor)−(first sensed output voltage of magnetic sensor).

16. The method according to claim 14, wherein the image forming apparatus further includes an optical sensor configured to sense the recording medium,
wherein the controller sets as a time measurement start point a point when the optical sensor is turned on, sets as a first output sensing time of the magnetic sensor a point when a time interval passes after the time measurement start point, sets as a second output sensing time of the magnetic sensor a point when a time interval passes after the first output sensing time of the magnetic sensor.

17. The method according to claim 11, wherein the controller
disengages the stopper from the actuator before the first output sensing of the magnetic sensor,
first senses the output of the magnetic sensor when the recording medium reaches the media sensor, and
second senses the output of the magnetic sensor in a time interval after the first output sensing time of the magnetic sensor.

18. The method according to claim 17, wherein the controller calculates the amount of skew by the following expression,
(Amount of skew)=Δv/(second sensing time of output of magnetic sensor−first sensing time of output of magnetic sensor),
where Δv=(second sensed output voltage of magnetic sensor)−(first sensed output voltage of magnetic sensor).

19. The method according to claim 17, wherein the controller detects the output of the magnetic sensor plural times, sets as the first output sensing time of the magnetic sensor a point when the controller detects that the output of the magnetic sensor is greater than a predetermined threshold value, and sets as the second output sensing time of the magnetic sensor a point when a time interval passes after the first output sensing time of the magnetic sensor.

20. The method according to claim 11, wherein the stopper reciprocates by a solenoid.
